(19) United States
(12) Patent Application Publication
(10) Pub. No.: US 2024/0291096 A1
(43) Pub. Date: Aug. 29, 2024

(54) BATTERY PACK

(71) Applicant: Prime Planet Energy & Solutions, Inc., Tokyo (JP)

(72) Inventors: Naotake YOSHIDA, Himeji-shi (JP); Satoru MATSUYAMA, Kasai-shi (JP)

(21) Appl. No.: 18/442,100

(22) Filed: Feb. 15, 2024

(30) Foreign Application Priority Data
Feb. 27, 2023 (JP) 2023-028163

(51) Int. Cl. H01M 50/317; H01M 50/242; H01M 50/249

(52) U.S. Cl. CPC H01M 50/317; H01M 50/242; H01M 50/249; H01M 2200/20; H01M 2220/20

(57) ABSTRACT

A battery pack includes: a battery assembly including a plurality of battery cells arranged side by side in a first direction; a case provided with an inner space that accommodates the battery assembly and a wall surface that defines at least a portion of the inner space; and a sealing component that extends through the wall surface to reach the inner space, wherein the wall surface is provided with a recess recessed toward the inner space when viewed from an outer portion side of the case, and a through hole reaching the inner space is formed in a bottom portion of the recess and the sealing component seals the through hole.

### CROSS REFERENCE TO RELATED APPLICATIONS

This nonprovisional application is based on Japanese Patent Application No. 2023-028163 filed on Feb. 27, 2023 with the Japan Patent Office, the entire contents of which are hereby incorporated by reference.

### BACKGROUND OF THE INVENTION

### Field of the Invention

The present technology relates to a battery pack.

### Description of the Background Art

Japanese Patent Laying-Open No. 2019-220592 discloses a structure of a ventilation unit that can suppress entry of water or the like into a case of an electrical component such as a battery pack for vehicle.

### SUMMARY OF THE INVENTION

A sealing property of an O-ring or the like needs to be avoided from being compromised even when an impact by water in high-pressure washing or the like is received. In view of this, it cannot be said that a conventional sealing structure is necessarily sufficient.

It is an object of the present technology to provide a battery pack having an improved sealing property against an impact by water in high-pressure washing or the like.

The present technology provides the following battery pack.
[1] A battery pack comprising: a battery assembly including a plurality of battery cells arranged side by side in a first direction; a case provided with an inner space that accommodates the battery assembly and a wall surface that defines at least a portion of the inner space; and a sealing component that extends through the wall surface to reach the inner space, wherein the wall surface is provided with a recess recessed toward the inner space when viewed from an outer portion side of the case, and a through hole reaching the inner space is formed in a bottom portion of the recess and the sealing component seals the through hole.
[2] The battery pack according to [1], wherein the wall surface is constituted of a plate-shaped member.
[3] The battery pack according to [1] or [2], wherein the sealing component includes a pressure regulation valve that is opened when an internal pressure of the inner space exceeds a predetermined value.
[4] The battery pack according to [3], further comprising an electrical component unit accommodated in the case, wherein the pressure regulation valve is located on a side opposite to the electrical component unit with respect to the battery assembly.
[5] The battery pack according to any one of [1] to [3], further comprising an electrical component unit accommodated in the case, wherein the sealing component includes a connector electrically connected to the electrical component unit.
[6] The battery pack according to any one of [1] to [5], wherein the sealing component is inserted in the through hole along a second direction orthogonal to the first direction.
[7] The battery pack according to any one of [1] to [6], wherein the recess is reduced in diameter from the outer portion of the case toward the inner space.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a configuration of a battery pack.

FIG. 2 is a perspective view of a battery assembly.

FIG. 3 is a perspective view showing a battery cell.

FIG. 4 is a perspective view of a case of the battery pack.

FIG. 5 is a side view of the case of the battery pack.

FIG. 6 is a cross sectional view showing a structure around a pressure regulation valve.

Each of FIG. 7 and FIG. 8 is a diagram showing an exemplary arrangement of the battery pack and the pressure regulation valve in a vehicle.

FIG. 9 is a perspective view showing surroundings of an electrical component unit in the battery pack.

FIG. 10 is a diagram showing a state in which the electrical component unit shown in FIG. 9 is viewed in a Y axis direction.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “battery” is not limited to a lithium ion battery, and may include other batteries such as a nickel-metal hydride battery and a sodium ion battery.

In the present specification, the term “battery cell” is not necessarily limited to a prismatic battery cell and may include a cell having another shape, such as a cylindrical battery cell, a pouch battery cell, or a blade battery cell. Further, the “battery cell” can be mounted on vehicles such as a hybrid electric vehicle (HEV), a plug-in hybrid electric vehicle (PHEV), and a battery electric vehicle (BEV). It should be noted that the use of the “battery cell” is not limited to the use in a vehicle.

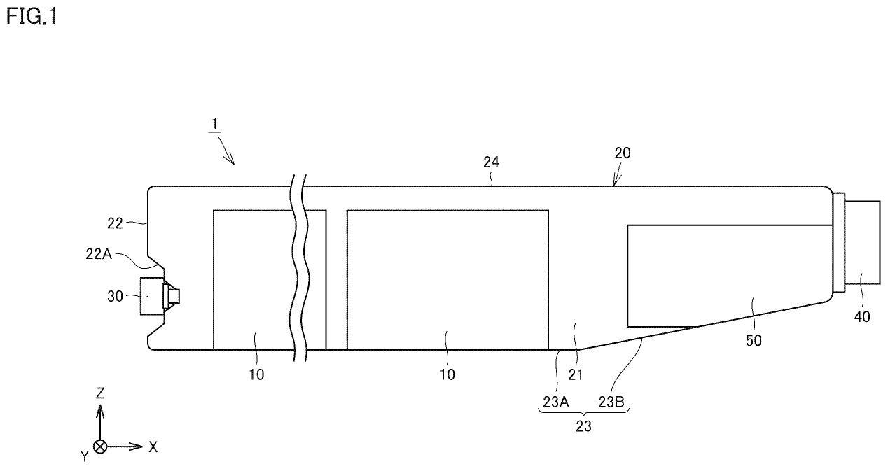

FIG. 1 is a diagram showing a configuration of a battery pack according to the present embodiment. As shown in FIG. 1, battery pack 1 includes battery assemblies 10, a case 20, a pressure regulation valve 30, a connector 40, and an electrical component unit 50.

Each of battery assemblies 10 includes a plurality of battery cells stacked in a Y axis direction. Case 20 is provided with: an inner space 21 that accommodates battery assembly 10 and electrical component unit 50; and a wall surface 22, a floor surface 23, and a cover surface 24 that each define inner space 21.

Wall surface 22 of case 20 is provided with a recess 22A recessed toward inner space 21 when viewed from an outer portion side of case 20. Floor surface 23 includes: a first floor surface portion 23A extending in an X-Y plane direction; and a second floor surface portion 23B obliquely intersecting with the X-Y plane direction.

Pressure regulation valve 30 extends through wall surface 22 of case 20 along an X axis direction to reach inner space 21 of case 20. Pressure regulation valve 30 is opened when internal pressure of inner space 21 of case 20 exceeds a predetermined value. Thus, the internal pressure of inner space 21 can be suppressed from being excessively increased.

In the example of FIG. 1, pressure regulation valve 30 is located on a side opposite to electrical component unit 50 with respect to battery assembly 10. Connector 40 is electrically connected to an electrical component included in electrical component unit 50.

Since pressure regulation valve 30 is provided on the side opposite to connector 40 and electrical component unit 50, gas from pressure regulation valve 30 can be suppressed from being discharged toward an operator during a maintenance operation on electrical component unit 50.

It should be noted that the shape of case 20 and the arrangement of battery assembly 10, pressure regulation valve 30, connector 40, and electrical component unit 50 in case 20 are not limited to those illustrated in FIG. 1. Further, a stacking direction of the battery cells in battery assembly 10 is not limited to the Y axis direction.

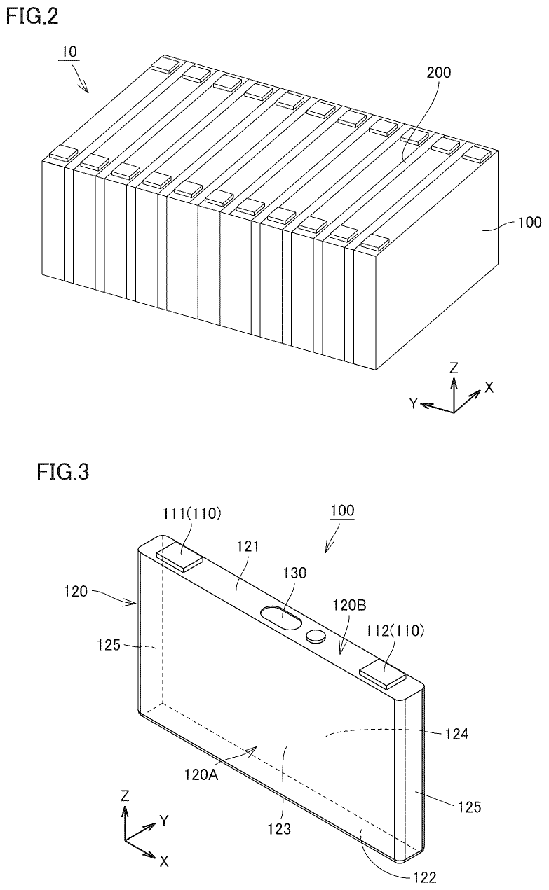

FIG. 2 is a perspective view of battery assembly 10. Battery assembly 10 shown in FIG. 2 includes battery cells 100 and insulating members 200 (inter-cell separators). Battery cells 100 and insulating members 200 are alternately arranged along the Y axis direction (first direction).

The plurality of battery cells 100 are battery cells each having a prismatic shape, and are provided along the Y axis direction. The plurality of battery cells 100 are electrically connected together by a bus bar (not shown).

Insulating members 200 are provided between the plurality of battery cells 100. Each of insulating members 200 prevents unintended electrical conduction between adjacent battery cells 100. Insulating member 200 secures an electrical insulation property between adjacent battery cells 100.

Battery assembly 10 is accommodated in case 20, thereby forming battery pack 1 shown in FIG. 1. Battery pack 1 may have a structure (Cell-to-Pack structure) in which wall surface 22 of case 20 directly supports the stack of battery cells 100 and insulating members 200, or may have a structure (Cell-Module-Pack structure) in which a battery module including the plurality of battery cells 100 and insulating members 200 is accommodated in case 20.

FIG. 3 is a perspective view showing each battery cell 100. As shown in FIG. 3, battery cell 100 has a prismatic shape. Battery cell 100 has electrode terminals 110, a battery case 120, and a gas-discharge valve 130.

Each of electrode terminals 110 is formed on battery case 120. Electrode terminals 110 have a positive electrode terminal 111 and a negative electrode terminal 112 arranged side by side along the X axis direction (second direction) orthogonal to the Y axis direction (first direction). Positive electrode terminal 111 and negative electrode terminal 112 are provided to be separated from each other in the X axis direction.

Battery case 120 has a rectangular parallelepiped shape and forms an external appearance of battery cell 100. Battery case 120 includes: a case main body 120A that accommodates an electrode assembly (not shown) and an electrolyte solution (not shown); and a sealing plate 120B that seals an opening of case main body 120A. Sealing plate 120B is joined to case body 120A by welding.

Battery case 120 has an upper surface 121, a lower surface 122, a first side surface 123, a second side surface 124, and two third side surfaces 125.

Upper surface 121 is a flat surface orthogonal to a Z axis direction (third direction) orthogonal to the Y axis direction and the X axis direction. Electrode terminals 110 are disposed on upper surface 121. Lower surface 122 faces upper surface 121 along the Z axis direction.

Each of first side surface 123 and second side surface 124 is constituted of a flat surface orthogonal to the Y axis direction. Each of first side surface 123 and second side surface 124 has the largest area among the areas of the plurality of side surfaces of battery case 120. Each of first side surface 123 and second side surface 124 has a rectangular shape when viewed in the Y axis direction. Each of first side surface 123 and second side surface 124 has a rectangular shape in which the X axis direction corresponds to the long-side direction and the Z axis direction corresponds to the short-side direction when viewed in the Y axis direction.

The plurality of battery cells 100 are stacked such that first side surfaces 123 of battery cells 100, 100 adjacent to each other in the Y direction face each other and second side surfaces 124 of battery cells 100, 100 adjacent to each other in the Y axis direction face each other. Thus, positive electrode terminals 111 and negative electrode terminals 112 are alternately arranged in the Y axis direction in which the plurality of battery cells 100 are stacked.

Gas-discharge valve 130 is provided in upper surface 121. When the temperature of battery cell 100 is increased (thermal runaway) and internal pressure of battery case 120 becomes more than or equal to a predetermined value due to gas generated inside battery case 120, gas-discharge valve 130 discharges the gas to outside of battery case 120.

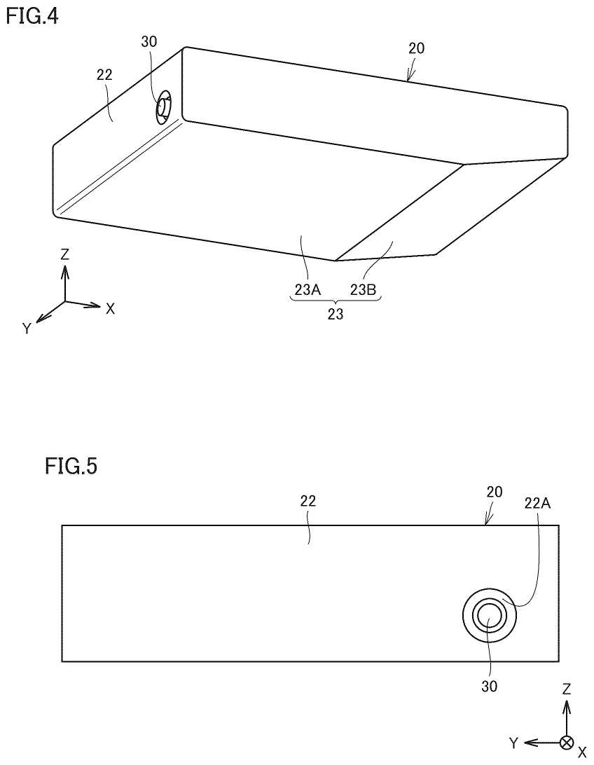

FIG. 4 is a perspective view of case 20 of battery pack 1, and FIG. 5 is a side view of case 20.

As shown in FIGS. 4 and 5, recess 22A provided in wall surface 22 is reduced in diameter from the outer portion of case 20 toward inner space 21 in the form of a circular truncated cone. Recess 22A is provided in the vicinity of a corner portion of case 20. Since rigidity of case 20 is high in the vicinity of the corner portion of case 20, deformation of case 20 is suppressed around pressure regulation valve 30 even when pressure in inner space 21 is increased. As a result, control for precisely operating pressure regulation valve 30 at a desired pressure is readily performed.

In the example of FIG. 5, for example, the expression “vicinity of the corner portion” means a region in which the center of recess 22A is close to an end portion of the case with respect to the center of the case between the center of case 20 in the Y axis direction (the center of the case) and the end portion of case 20 in the Y axis direction (the end portion of the case). In the example of FIG. 5, in the Z axis direction, the center of recess 22A is located at a position away from the center of case 20 in the Z axis direction (position shifted to the lower side in FIG. 5).

It should be noted that the shapes and positions of recess 22A and pressure regulation valve 30 are not limited to those illustrated in FIG. 5. For example, each of recess 22A and pressure regulation valve 30 may be provided in wall surface 22 extending in the X-Z plane direction.

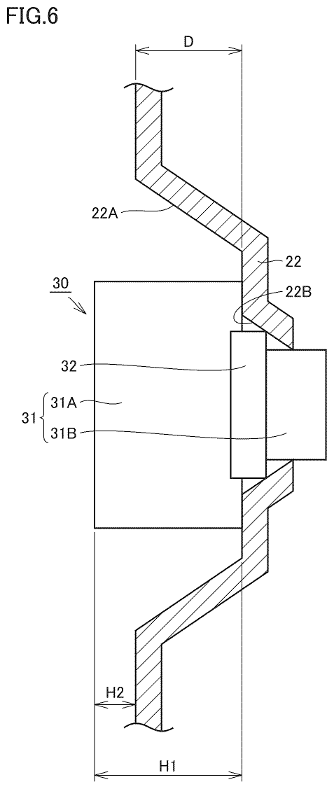

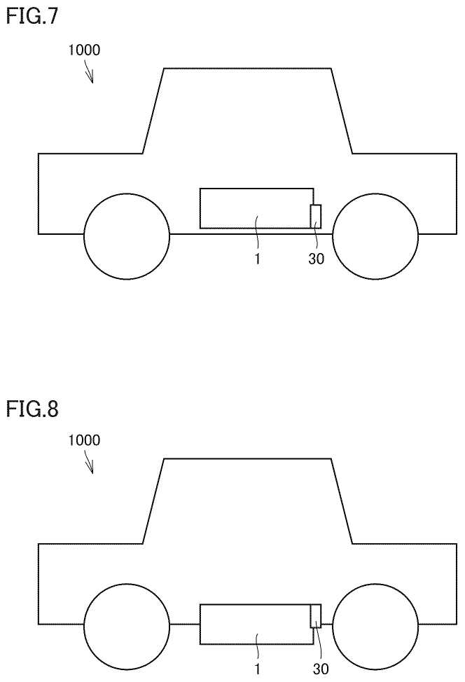

FIG. 6 is a cross sectional view showing a structure around pressure regulation valve 30. As shown in FIG. 6, wall surface 22 of case 20 is constituted of a plate-shaped member. Recess 22A is formed by performing a drawing process onto the plate-shaped member. A through hole 22B reaching inner space 21 is formed in a bottom portion of recess 22A. Recess 22A has a depth D.

Pressure regulation valve 30 includes a plug 31 and a sealing member 32. Plug 31 includes a main body portion 31A and a fit-in portion 31B. Fit-in portion 31B of plug 31 is inserted into through hole 22B. Sealing member 32 seals between fit-in portion 31B of plug 31 and through hole 22B of case 20.

Main body portion 31A of plug 31 has a height H1. In the example of FIG. 5, since height H1 of main body portion 31A is larger than depth D of recess 22A (H1>D), plug 31 protrudes with respect to the outer surface of case 20 by a difference H2 (H1−D) therebetween. This difference H2 is, for example, about 0.5 mm.

Thus, since plug 31 protrudes by the slight amount with respect to the outer surface of case 20 adjacent to recess 22A, a space for providing a jig for pressing plug 31 into through hole 22B can be secured, with the result that pressure regulation valve 30 can be simply and securely installed.

As shown in FIG. 6, since through hole 22B is provided in the bottom portion of recess 22A and plug 31 is inserted therein to provide pressure regulation valve 30, at least a portion of the surroundings of pressure regulation valve 30 can be shielded, thereby suppressing the sealing property of pressure regulation valve 30 from being compromised by an impact by water at the time of high-pressure washing. As a result, entry of water into inner space 21 of case 20 via through hole 22B is suppressed.

Further, since recess 22A is reduced in diameter toward inner space 21, a slope can be formed on the lower side (lower side in FIG. 6) of battery pack 1 so as to allow water to flow to the outside of case 20, thereby more effectively suppressing the entry of water into inner space 21.

Further, since recess 22A is formed, rigidity of the plate-shaped member included in case 20 is increased around recess 22A. As a result, as described above, the control for precisely operating pressure regulation valve 30 at a desired pressure is readily performed. Further, when pressure regulation valve 30 is opened, pressure regulation valve 30 can be readily suppressed from being detached in an unintended manner.

Each of FIGS. 7 and 8 is a diagram showing an exemplary arrangement of battery pack 1 and pressure regulation valve 30 in a vehicle.

In the example of FIG. 7, a whole of battery pack 1 is covered with vehicle components in a state in which battery pack 1 is attached to a lower portion of a vehicle 1000. In this case, an influence of an impact by water in high-pressure washing or the like on vehicle 1000 is relatively small.

On the other hand, in the example of FIG. 8, a lower portion of battery pack 1 protrudes from the lower portion of vehicle 1000 in the state in which battery pack 1 is attached to the lower portion of vehicle 1000. In this case, the influence of the impact by water is large in high-pressure washing or the like on vehicle 1000. Since pressure regulation valve 30 is attached to the upper portion of battery pack 1 so as to cover pressure regulation valve 30 with the vehicle components, water can be suppressed on this occasion from entering case 20 via through hole 22B for attaching pressure regulation valve 30.

Thus, the attachment position of pressure regulation valve 30 in case 20 can be changed in accordance with a mounting position, a mounting direction, or the like of battery pack 1 in vehicle 1000.

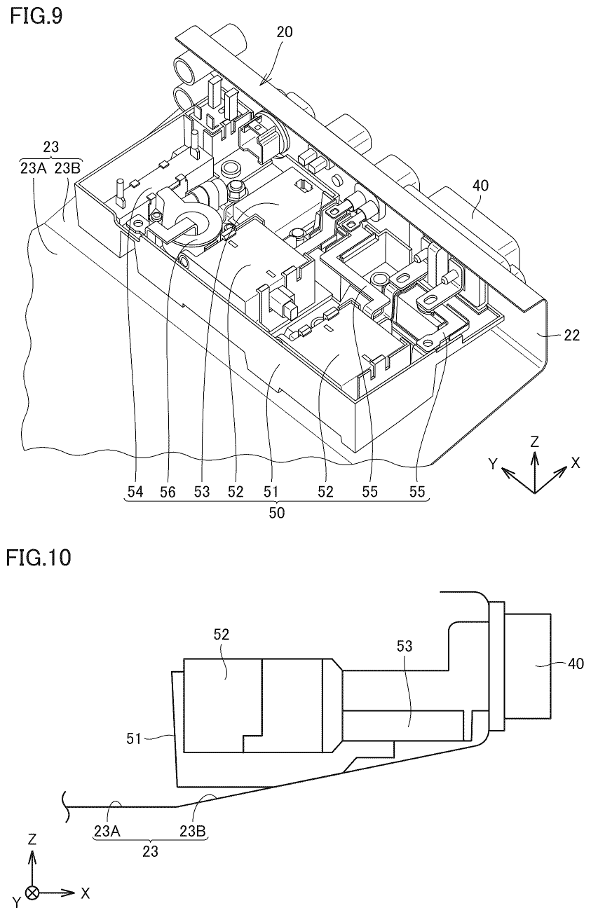

FIG. 9 is a perspective view showing surroundings of the electrical component unit. FIG. 10 is a diagram showing a state in which the electrical component unit shown in FIG. 9 is viewed in the Y axis direction.

As shown in FIGS. 9 and 10, connector 40 is provided in wall surface 22 of case 20. Connector 40 forms a power supply port for battery cells 100 and electrical component unit 50 accommodated in case 20.

A housing 51 of electrical component unit 50 accommodates electronic components including a main relay 52, a shunt resistor 53, a cement resistor 54, a bus bar 55, and a current sensor 56. Other electronic components not shown in FIGS. 9 and 10 may be accommodated in housing 51, such as a fuse and a pre-charging relay.

The electronic components accommodated in housing 51 include: a first electronic component (for example, main relay 52, current sensor 56, or the like) having a relatively large height in the Z axis direction; and a second electronic component (for example, shunt resistor 53, cement resistor 54, or bus bar 55) having a relatively small height in the Z axis direction. Since the second electronic component having the small height is disposed close to the wall surface 22 side with respect to the first electronic component having the large height, inner space 21 of case 20 located on second floor surface portion 23B can be effectively utilized.

The various illustrations in the present embodiment are not intended to limit the scope of the present technology to exceed the scope of claims. For example, in the present embodiment, the structure of pressure regulation valve 30 provided in recess 22A has been described; however, a similar structure may be applied to an installation portion for connector 40, for example.

Further, pressure regulation valve 30 and connector 40 may be disposed adjacent to each other so as to block an impact by water from each other. Further, a shielding structure (which may be in one piece with case 20 or may be a separate component) such as a rib may be provided around recess 22A of case 20 so as to block at least part of the impact by water.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A battery pack comprising:
a battery assembly including a plurality of battery cells arranged side by side in a first direction;
a case provided with an inner space that accommodates the battery assembly and a wall surface that defines at least a portion of the inner space; and
a sealing component that extends through the wall surface to reach the inner space, wherein
the wall surface is provided with a recess recessed toward the inner space when viewed from an outer portion side of the case, and
a through hole reaching the inner space is formed in a bottom portion of the recess and the sealing component seals the through hole.

2. The battery pack according to claim 1, wherein the wall surface is constituted of a plate-shaped member.

3. The battery pack according to claim 1, wherein the sealing component includes a pressure regulation valve that is opened when an internal pressure of the inner space exceeds a predetermined value.

4. The battery pack according to claim 3, further comprising an electrical component unit accommodated in the case, wherein
the pressure regulation valve is located on a side opposite to the electrical component unit with respect to the battery assembly.

5. The battery pack according to claim 1, wherein
the wall surface is constituted of a plate-shaped member, and
the sealing component includes a pressure regulation valve that is opened when an internal pressure of the inner space exceeds a predetermined value.

6. The battery pack according to claim 1, wherein
the wall surface is constituted of a plate-shaped member, and
the sealing component includes a pressure regulation valve that is opened when an internal pressure of the inner space exceeds a predetermined value,
the battery pack further comprising an electrical component unit accommodated in the case, wherein
the pressure regulation valve is located on a side opposite to the electrical component unit with respect to the battery assembly.

7. The battery pack according to claim 1, further comprising an electrical component unit accommodated in the case, wherein
the sealing component includes a connector electrically connected to the electrical component unit.

8. The battery pack according to claim 1, wherein the wall surface is constituted of a plate-shaped member,
the battery pack further comprising an electrical component unit accommodated in the case, wherein
the sealing component includes a connector electrically connected to the electrical component unit.

9. The battery pack according to claim 1, wherein
the wall surface is constituted of a plate-shaped member, and
the sealing component includes a pressure regulation valve that is opened when an internal pressure of the inner space exceeds a predetermined value,
the battery pack further comprising an electrical component unit accommodated in the case, wherein
the sealing component includes a connector electrically connected to the electrical component unit.

10. The battery pack according to claim 1, wherein the sealing component is inserted in the through hole along a second direction orthogonal to the first direction.

11. The battery pack according to claim 1, wherein
the wall surface is constituted of a plate-shaped member, and
the sealing component includes a pressure regulation valve that is opened when an internal pressure of the inner space exceeds a predetermined value,
the battery pack further comprising an electrical component unit accommodated in the case, wherein
the pressure regulation valve is located on a side opposite to the electrical component unit with respect to the battery assembly, and
the sealing component is inserted in the through hole along a second direction orthogonal to the first direction.

12. The battery pack according to claim 1, wherein the wall surface is constituted of a plate-shaped member,
the battery pack further comprising an electrical component unit accommodated in the case, wherein
the sealing component includes a connector electrically connected to the electrical component unit, and
the sealing component is inserted in the through hole along a second direction orthogonal to the first direction.

13. The battery pack according to claim 1, wherein the recess is reduced in diameter from the outer portion of the case toward the inner space.

14. The battery pack according to claim 1, wherein
the wall surface is constituted of a plate-shaped member, and
the sealing component includes a pressure regulation valve that is opened when an internal pressure of the inner space exceeds a predetermined value,
the battery pack further comprising an electrical component unit accommodated in the case, wherein
the pressure regulation valve is located on a side opposite to the electrical component unit with respect to the battery assembly, and
the recess is reduced in diameter from the outer portion of the case toward the inner space.

15. The battery pack according to claim 1, wherein the wall surface is constituted of a plate-shaped member,
the battery pack further comprising an electrical component unit accommodated in the case, wherein
the sealing component includes a connector electrically connected to the electrical component unit, and
the recess is reduced in diameter from the outer portion of the case toward the inner space.
